(19) United States
(12) Patent Application Publication
(10) Pub. No.: US 2016/0250637 A1
(43) Pub. Date: Sep. 1, 2016

(54) VIRTUAL DETERMINISTIC LATERAL DISPLACEMENT FOR PARTICLE SEPARATION USING SURFACE ACOUSTIC WAVES

(71) Applicant: MONASH UNIVERSITY, Clayton, Victoria (AU)

(72) Inventors: Adrian NEILD, Victoria (AU); Tuncay ALAN, Victoria (AU); David John COLLINS, Victoria (AU)

(21) Appl. No.: 15/031,308

(22) PCT Filed: Oct. 27, 2014
(86) PCT No.: PCT/AU2014/050312

§ 371 Date: Apr. 22, 2016

(30) Foreign Application Priority Data
Oct. 25, 2013 (AU) 2013904130

(51) Int. Cl. B01L 3/00; G01N 27/447; G01N 15/10

(52) U.S. Cl. CPC B01L 3/502715; B01L 3/502761; B01L 3/50273; G01N 15/1056; G01N 15/1031; G01N 27/44791; G01N 27/4473; B01L 2200/0652; B01L 2300/06; B01L 2300/0887; B01L 2400/0436; B01L 2400/0424; G01N 2015/1081

(57) ABSTRACT

A microfluidic device for separating or sorting particles in a fluid including: a substrate; a plurality of interdigital transducers on the substrate; a microfluidic channel adapted to have fluid flow within, located over the interdigital transducers, the microfluidic channel having a width, wherein: the interdigital transducers are located within the width of the microfluidic channel; and application of a signal to the interdigital transducers produces a force field at an angle to the fluid flow direction within the microfluidic channel. In addition, a method for separating or sorting particles using a device having a plurality of interdigital transducers on a substrate and a microfluidic channel located over the interdigital transducers, the method including: positioning the interdigital transducers within the microfluidic channel width; inserting into the microfluidic channel a solution having particles with various properties; and applying a signal to the interdigital transducers to produce a force field at an angle to a fluid flow direction within the microfluidic channel to sort and/or physically separate the particles into groups of particles with the same property.

### FIELD OF THE INVENTION

The present invention is generally directed to a microfluidic system, device and method for sorting or separating particles, and is in particular directed to sorting or separating particles according to particular physical properties of the particles including size, density and stiffness or electrical properties. While the invention will be described with respect to a microfluidic separation technique using surface acoustic waves, it will be appreciated that the invention is not restricted to the use of acoustic fields, and any spatially periodic force field can also be used, such as a dielectrophoretic (DEP) force field.

### BACKGROUND TO THE INVENTION

The separation of particles and cells is fundamental to a variety of chemical, biological and industrial processes where the concentration of a particular analyte is used to increase diagnostic detection efficiency or therapeutic efficacy. Compared to conventional techniques, microfluidic systems can perform particle separation with less reagent, time and cost while taking advantage of forces that may be inapplicable on the macro-scales. Typically an external field is applied to the fluid/particle mixture to enable separation, the efficiency of which is determined by the differential impact the field has on particles with different properties. Microfluidic particle separation in continuous flow systems has been demonstrated using hydrodynamic, magnetic, optical, dielectrophoretic (DEP), acoustic, and passive mechanical methods, including brownian ratchets and deterministic lateral displacement (DLD), with each of these techniques having different advantages and operating ranges in terms of allowable sizes and throughput.

DLD devices consist of microfluidic channels containing a periodic array of pillars such that each row is offset in the lateral direction. This broken symmetry results in multiple streamlines that co-exist within the channel. Particles with a diameter smaller than a critical value travel with the forward flow, while larger particles are “bumped” sideways. In addition to their sensitivity, DLD devices have the additional advantage of being a non-contact system without pre treatment requirements. However, as separation depends on the geometric distribution of the pillars, individual devices must be fabricated to suit specific particle size ranges. Similarly, any structural irregularities affect the flow profile (due to the number of pillars there is a large number of sites for potential defects). Moreover, relatively long length scales are required to achieve significant separation.

This non-ultrasonic method uses an array of pillars in the channel to achieve sorting. As the fluid flows past the pillars, the particles will bump into them. In squeezing between pillars the particles are forced into certain flow lines, this affects their trajectory as they approach the next row of pillars. By having many rows of pillars with an asymmetrical offset, a probability of translation can occur at each row and as such over multiple rows separation can be achieved. This is a method which has been tested and is successful, the major drawback is the need to have a long channel in order to fit in enough pillar rows, and the high probability of stiction and clogging in the channel.

Acoustic fields have the potential to address these issues, though they can be difficult to integrate into microfluidic systems. However, “Continuous particle separation in a microfluidic channel via standing surface acoustic waves”, Lab on a Chip, 9, 23:3354-3359 Shi et al. demonstrated a particle separation device using surface acoustic waves (SAW) instead of a bulk transducer to create an acoustic field in a half-wavelength channel.

Half wavelength resonating channels, however are limited in their separation sensitivity due to the short distance (¼λ) over which particles are separated, with separation of particles with relatively large size differences, often limited to approximately 300-400%, typically reported.

The ongoing interest in hand held biomedical diagnostics and lab-on-chip systems has attracted a significant attention to particle manipulation in microfluidic systems. Ultrasonic induced acoustic radiation forces (ARF) can be used to manipulate particles suspended in a fluid. Upon excitation of the fluid (usually at ultrasonic frequencies) ARF will act to move particles to the force potential minima or maxima, in a standing wave field these coincide with the pressure nodes or antinodes.

A prior art method is a time based interaction with a single force potential minimum. In this method an ultrasonic standing wave is established across the width of a microfluidic channel (the minima is parallel to the length axis of the channel). As a result of this standing wave, particles moving along the channel in a flowing fluid migrate to the pressure node. Hence the interaction is with a single potential minimum. The speed of this migration depends on the radius (R) of the particles, as the ARF is proportional to R³ and the resisting drag force (proportional to R). Hence sorting can be achieved. Typically the particles are exposed to an ultrasonic field over a certain length of the channel, for a certain time (due to fluid flow), during which they migrate to the pressure node with the larger particles getting closer to this stable destination. At the end of the ultrasonic field a partition in the channel can be used to collect the particles into different samples. The major issue with this method, which is used widely, is that a balance needs to be obtained between the ARE strength and the flow speed. This leads to technical difficulties as the end position of the particles is highly dependent on this balance. Sorting using this method can only be achieved between quite distinct particles.

Another method that has been used is interaction with a single force potential minimum-contrast based sorting. In this method sorting is not by size, but rather by the stiffness and density of the particles (the two main parameters cannot be separated). Particles which are stiffer and denser than a fluid in which they are suspended will migrate into the pressure nodes in an ultrasonic standing wave, however, there are other combinations of stiffness and density which cause the particles to migrate to the pressure nodes. This method has been used extensively to sort biological samples. The major difficulty with this method is that the right suspension parameters must be found, such that one population moves to the node and the other to the antinode.

Another method is interaction with a travelling wave. In most instances ARF is used in a standing resonant ultrasonic wave for reasons of maximising available force amplitude. However, it is possible to use either a constantly changing standing wave field (by altering the excitation frequency over time) or a travelling wave. In the former, separation can be achieved, albeit poorly, based on the ability of the particle to follow the change of the standing wave. In the latter, the forces applied to the particle cause them to migrate away from the ultrasonic source, again this migration is time dependant, hence separation is achievable.

Problems arise in this method due to the difficulty in establishing a properly travelling wave (reflections of the propagating ultrasound are inevitable) and the high powers required such that the force amplitude reaches a usable level. Again issues arise due to the need to carefully match field amplitude with the fluid flow through the device as the fluid flow rate determines the length of exposure of the particles to the force field. Again the interaction is with a single force potential minimum.

There are some reports of particle separation in more complex ultrasonic fields. There are various patents that use multiple transducers to define a moveable ultrasonic field, one example is Cochran et. al. (US patent publication no. 20130047728). The problem with such systems is that they are very difficult to control, and would not be expected to be robust enough for use outside the laboratory. The principle is that if the field is moving, then sorting can be achieved by the ability of the particle to follow the field.

### SUMMARY OF THE INVENTION

It is an object of the present invention to improve on the capabilities of microfluidics for particle separation through the development of a novel method for dynamically tunable particle sorting using SAW with excellent separation efficiencies.

According to one aspect of the present invention, there is provided a microfluidic device for separating or sorting particles in a fluid including: a substrate: a plurality of interdigital transducers on the substrate; a microfluidic channel adapted to have fluid flow within, located over the interdigital transducers, the microfluidic channel having a width, wherein: the interdigital transducers are located within the width of the microfluidic channel; and application of a signal to the interdigital transducers produces a force field at an angle to the fluid flow direction within the microfluidic channel.

Preferably the force field is periodic. In addition, the force field may be acoustic. Alternatively the force field may be electrical, and preferably, dielectrophoretic (DEP). Alternatively the force field may be acoustic and electrical. If the force field is electrical, preferably it is dielectrophoretic (DEP).

Preferably the substrate may be glass, a non-piezoelectric material or a piezoelectric substrate.

The interdigital transducers are preferably in direct contact with fluid in the microfluidic channel. Alternatively, the interdigital transducers may be separated from fluid in the microfluidic channel. The interdigital transducers may be separated from fluid in the microfluidic channel by at least one intermediate layer.

Preferably the particles are separated or sorted based on a physical property. The physical property used to separate the particles may be any one or more of size, density, length, area or stiffness.

Alternatively the particles may be separated or sorted based on electrical properties, such that after travelling through the force field particles with different properties are physically separated.

The particles to be sorted are preferably an inhomogeneous body within a suspending medium, including any one of: a particle; nanoparticle: cell; virus; vesicle; carbon nanostructure; or droplet.

According to another aspect of the present invention, there is provided a method for separating or sorting particles using a device having a plurality of interdigital transducers on a substrate and a microfluidic channel located over the interdigital transducers, the method including: positioning the interdigital transducers within the microfluidic channel width; inserting into the microfluidic channel a solution having particles with various properties; and applying a signal to the interdigital transducers to produce a force field at an angle to a fluid flow direction within the microfluidic channel to sort and/or physically separate the particles into groups of particles with the same property.

The method may further include the steps of tuning the fluid flow and tuning the force field strength to define particle size separation. Preferably the step of tuning the force field strength is determined by the distance between the interdigital transducers and the microfluidic channel or the distance between the interdigital transducers and the particles in the microfluidic channel.

Preferably the method for separating or sorting particles uses the device as described above.

The method preferably separates or sorts particles based on a physical property. Preferably, the physical property is any one or more of size, density, length, area or stiffness. Alternatively, the particles may be separated or sorted based on an electrical property.

According to a further aspect of the present invention, there is provided a system for separating or sorting particles using the device as described above.

The method of an embodiment of the present invention is deterministic in that particles with a particular physical parameter, for example, above a critical size will be sorted from smaller ones, and virtual in that the periodic force field—the equivalent of pillars in a DLD array—is non-physical and can be adjusted to suit a given size range. Because the separation of particles for given sizes is determined only by the frequency, amplitude and flow rate, it is possible to separate particles over a wide size range, from nanometers to micrometers, all using the same device.

### BRIEF DESCRIPTION OF THE DRAWINGS

The present invention will now be described with reference to the following drawings which illustrate experiments conducted using the present invention. It is to be appreciated that the present invention is not limited to the experimental example and that other embodiments are also envisaged. Consequently the particularity of the accompanying drawings is not to be understood as superseding the generality of the preceding description of the invention.

In the drawings:

FIG. 1 shows a virtual deterministic lateral displacement (vDLD) device employing high frequency surface acoustic waves (SAW) and/or a dielectrophoretic force field according to an embodiment of the present invention.

FIG. 2 shows a particle in the vDLD device depicted in FIG. 1 is subject to opposing forces of acoustic force F_{ac} and viscous drag F_{D}.

FIGS. 3(a) and 3(b) show the separation and hence particle sorting which occurs using the vDLD device according to embodiments of the present invention. FIG. 3(a) shows particle separation and sorting that occurs when using a DEP dominant vDLD device and FIG. 3(b) shows particle separation and sorting that occurs when using an acoustic dominant vDLD device.

FIGS. 4(a) and 4(b) show separation efficiencies of two particle population sets which have been separated using the vDLD device according to embodiments of the present invention. FIG. 4(a) shows separation efficiencies that occur when using a DEP dominant vDLD device and FIG. 4(b) shows separation efficiencies that occur when using an acoustic dominant vDLD device.

FIG. 5 shows separation of particles passing through the vDLD device according to an embodiment of the present invention.

FIG. 6 shows simulated particle trajectories which result from using a device according to an embodiment of the present invention.

FIG. 7 shows the force field that occurs during separation of particles according to an embodiment of the present invention.

### DESCRIPTION OF THE INVENTION

The following description in conjunction with the accompanying drawings describes various examples of virtual deterministic lateral displacement (vDLD) devices and methods according to embodiments of the present invention.

Particle as used herein is used to refer to an inhomogeneous body within a suspending medium, for example, a particle, nanoparticle, cell, virus, vesicle, droplet, carbon nanostructure, etc.

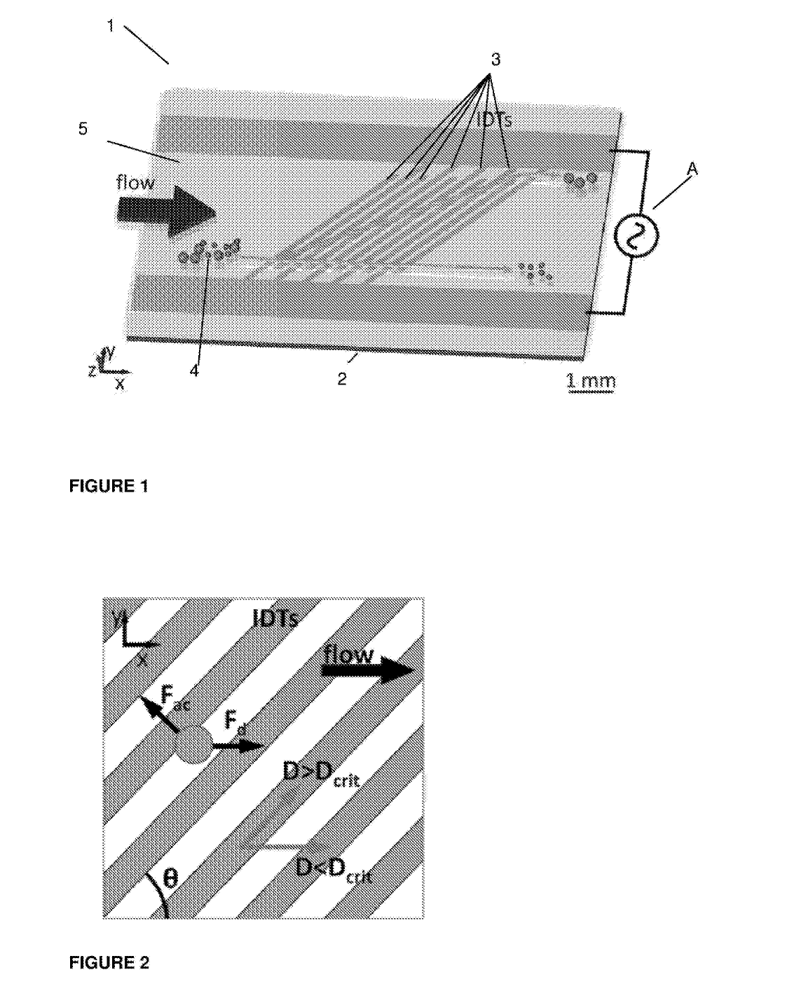

A vDLD device 1 employing high frequency SAW is depicted in FIG. 1. In this figure, a solution containing dissimilarly sized particles 4 is passed through a force field, induced by an array of interdigital transducers (IDTs) 3 on a piezoelectric lithium niobate (LN) substrate 2. In an alternate embodiment the substrate could be glass.

Particles in the acoustic force dominant embodiment of the vDLD array are subject to both the acoustic force at a pressure antinode F_{ac} and viscous drag F_{D}. Particles where F_{ac}<F_{D} are relatively unaffected in their lateral progression and continue to move in the direction of the flow. This method is dynamically tunable, not being restricted to a given particle size range and is applicable to a variety of particles, including cells. Importantly, using this method and device, separation with only fractional differences in particle sizes is possible, with the effective separation of 5.0 μm/6.6 μm, 6.6 μm/7.0 μm and 300 nm/500 nm particles.

The vDLD device includes a microfluidic channel 5 (or chamber) aligned on top of a high-frequency SAW device. The SAW device shown in FIG. 1 has a series of aluminium interdigital transducers (IDTs) arrayed on a lithium niobate (LN) substrate 2. The IDTs 3 are located (arrayed) within the width of the microfluidic channel 5. The IDTs 3 are not outside of the width of the channel. When an alternating current (A/C) signal 6 is applied across the IDTs 3 at a resonant frequency f, where f=cₛ/λ_{SAW}, and cₛ is the sound speed in the substrate and λ_{SAW} is the spacing between successive IDT finger-pairs, the surface displacements emanating from a finger-pair are reinforced by those of nearby finger-pairs. These displacements transfer into the fluid (solution) in the microfluidic channel 5 which is on top of a set of IDTs to create an acoustic field in the fluid. The microfluidic channel can be directly on top of the IDTs such that the IDTs are in contact with the microfluidic channel or the fluid in the microfluidic channel. Alternatively, the microfluidic channel may be on top of the IDTs but have an intermediate layer, such as a coating of PDMS, or more than one intermediate layer between the microfluidic channel and the IDTs.

The vDLD device as shown in FIG. 1 consists of a 12 finger-pair 80 μm wavelength set of 5 nm chrome/250 nm aluminium IDTs 3 arrayed on a 0.5 mm thick, double side polished 128° Y-cut, X-propagating LN substrate 2 operating at 49.5 MHz. To insulate the transducers, prevent corrosion and promote adhesion with the polydimethylsiloxane (PDMS) chamber, the device was coated with 200 nm of SiO₂. The PDMS (1:5 ratio of curing agent/polymer) channel, with height approximately 15 μm, was bonded with the device after exposure to an air plasma (Harrick Plasma PDC-32G, Ithaca, N.Y., 1000 mTorr, 18 W). Polystyrene particles (Magsphere, Pasadena, Calif., USA) enter the symmetric 5 mm wide channel through a 20 μm particle injection port. Due to the high aspect ratio (approximately 300:1), 200 μm wide channel supports are required to prevent collapse and maintain channel height. The buffer solution consisted of deionized water (Milli-Q 18.2 MΩ·cm, Millipore, Billerica, Mass.) with 0.2% polyethylene glycol to prevent particle adhesion. Experiments were visualized using a fluorescent microscope (Olympose BX43, Tokyo, Japan) and imaged using a 5MP C-mount camera (Dino-Lite AM7023CT, New Taipaei City, Taiwan).

A particle immersed in a standing wave pressure field experiences a time averaged force F_{ac}=−∇ [symbol] U [symbol] , with

$$4 〈 U 〉 = π {D}^{3} {ρ}_{f} ( \frac{1}{3} \frac{〈 {P}^{2} 〉}{{ρ}_{f}^{2} {c}_{f}^{2}} {f}_{1} - \frac{1}{2} 〈 {v}^{2} 〉 {f}_{2} ) \qquad ( 1 )$$

where [symbol] U [symbol] is the Gor'kov force potential, [symbol] P² [symbol] and [symbol] v² [symbol] represent the mean squared fluctuations within the pressure and fluid particle velocity fields respectively, fᵢ=1−ρ_{f}c_{f}²/ρₚcₚ², and f₂=2(ρₚ−ρ_{f})/(2ρₚ+ρ_{f}), where ρ_{f}, ρₚ and c_{f}, cₚ are the density and sound speeds of the fluid and particles respectively.

A particle in the sound field generated by the IDTs will experience a force F_{ac}=F_{ac}^{max} sin (2k(x sin(θ)−y cos(θ))), where the IDTs are angled against the flow direction at an angle θ. Additionally, a particle immersed in an electric field will be subject to a time-averaged dielectrophoretic (DEP) force, given by

F_{DEP}=2πεₘR³Re(K)∇|Eᵣₘₛ|² (2)

where εₘ is the permittivity of the media, Re(K) is the real part of the Clausius-Mossotti factor, dependent on the relative permittivity of the particle and media, varying between −0.5 and 1, and Eᵣₘₛ s the root-mean-square electric field.

A particle in a fluid flow will also be subject to viscous drag force F_{D}, given by

F_{D}=6πμRu (3)

where μ is the fluid viscosity, R is the particle radius and u is the differential velocity between particle and fluid.

The local pressure and flow velocity experienced by a particle will be determined by the particle dimensions. FIG. 2 shows that a particle in the acoustic-dominant vDLD device is subject to opposing forces of acoustic force F_{ac} and viscous drag F_{D}. In a DEP dominant vDLD device, the forces, both DEP and drag, experienced by a particle is a function of the particle size.

The dominant force can be affected by the choice of substrate, the height of the microfluidic channel, which contains the fluid, above the IDTs and/or the inclusion of one or more intermediate layers between the IDTs and the microfluidic channel containing the fluid, for example a coating of PDMS.

The vDLD device of the present invention may exert different forces on particles which are in the solution of fluid in the microfluidic channel. In one embodiment the device may exert only acoustic force if the IDTs are physically separated from the microfluidic channel, by for example an intermediate layer.

In another embodiment the vDLD device may exert both acoustic force and DEP force on particles in the solution if the IDTs are not physically separated from the microfluidic channel by a separate physical layer. However, the distance of the IDTs from the channel determines which of acoustic or DEP force is more dominant.

If the IDTs are close to the channel the DEP force will be more dominant. Whereas if the IDTs are further away from the channel, the acoustic force will be more dominant. As such, the predominant force, DEP or acoustic, acting on a particle is determined by its distance above the IDTs. DEP force is dominant in the near-field and acoustic force is dominant for larger distances from the transducers. As such, adjusting the distance or height between the particles in the fluid and the IDTs determines which force (or forces) will act or which force will be more dominant for a particular application. Therefore, sorting or separating particles in the fluid by a particular property is related to which force is dominant and the strength of the force. That is, selection of which force is to be dominant and the strength of that force is key to sorting or separating particles by a particular property. Further the distance between the IDTs and the particles in the fluid determine which force is dominant and hence according to which property the particles will be sorted to.

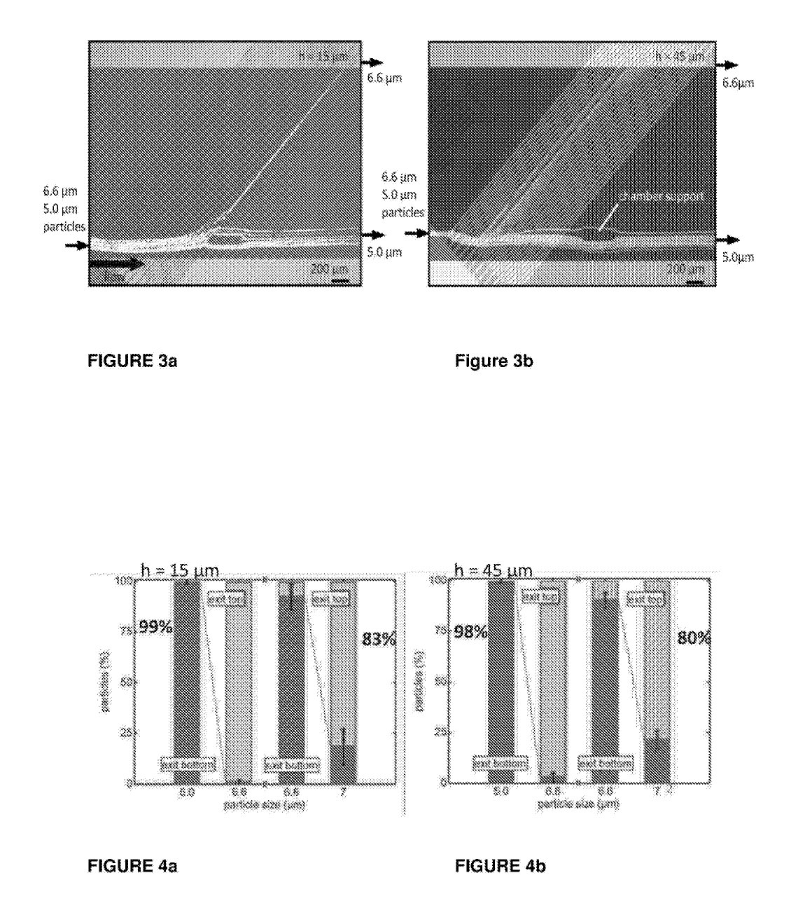

FIGS. 3(a) and 4(a) show results when using a vDLD device with a channel height of 15 μm (h=15 μm), as such, the DEP force is more dominant because the fluid in the microfluidic channel is close to the IDTs. While FIGS. 3(b) and 4(b) show results when using a vDLD device with a channel height of 45 μm (h=45 μm), as such the acoustic force is more dominant because the microfluidic channel is further away from the IDTs. FIGS. 3(a) and 3(b) show deterministic particle sorting. FIG. 3(a) depicts particle sorting in a dielectrophoretic (DEP) dominant vDLD device, whereas FIG. 3(b) depicts particle sorting in an acoustic force dominant vDLD device. FIGS. 3(a) and 3(b) show a maximum intensity plot of fluorescent particles overlaid on a brightfield image of the device, where a solution of blue 5.0 μm and orange 6.6 μm (θ_{5.0}=0.21 μm, θ_{6.6} 0.22 μm) particles pass through a vDLD array, angled at θ=45° to the flow direction, with particles of diameters D>D_{crit} being vertically separated from particles with D<D_{crit}. FIGS. 4(a) and 4(b) show the respective separation efficiencies of two particle population sets 5.0 μm, 6.6 μm and 6.6 μm, 7.0 μm (θ_{7.0}=0.25 μm), where 4(a) is for a DEP dominant vDLD device and 4(b) is for an acoustic dominant vDLD device. Separation efficiency of the particle populations is limited by the existing overlap in their size distributions.

FIGS. 3 and 4 show the deterministic sorting of particles; particles with diameters D<D_{crit} (blue) will be able to proceed with minimal lateral displacement, albeit more slowly than the freestream fluid velocity. In contrast, spherical particles above a critical diameter D_{crit}, occurring at F_{ac/DEP}≧F_{D} will not be able to pass across a pressure antinode. At the start of the channel (lett), with this condition not being met, the larger particles (orange) cross from one IDT pair to the next, though are still slightly retarded and laterally shifted. By designing the device such that the particles are introduced into an enveloping buffer at the centre of the channel, each lateral displacement moves the particles into slower flowing fluid, with the acoustic force becoming increasingly dominant, corresponding to increasing lateral shifts. Eventually the fluid flow is reduced such that F_{ac/DEP}≧F_{D}; for optimum sorting, this condition should occur at the last possible force field antinode.

In FIG. 3, particles were counted individually as they passed through the array in the DEP dominant device (FIG. 3(a)) and acoustic force dominant device (FIG. 3(b)). Here, 5.0 μm and 6.6 μm (green and orange) particles enter the vDLD array with 99.1±0.7%/99.5±0.9% and 99.3±1.3%/97.3±2.1% [DEP/acoustic force dominant] of each particle size range successfully separated, with the larger 6.6 μm exiting the pressure field separated by the vertical span of the IDTs. For both of the particle size ranges separated in FIG. 4(a) the quantity of unsorted particles, that is, those observed to follow an unintended trajectory, is of the same order of the value of overlap in the particle size distribution (see particle size data in FIG. 4). It can be seen in FIG. 3a that the applied voltage and flow rate have been tuned specifically to place the larger (orange) particles in the final force field node. Increasing amplitude or decreasing flaw velocity would cause particles to follow a node encountered earlier, decreasing the sensitivity of the device to the particular size range tested here.

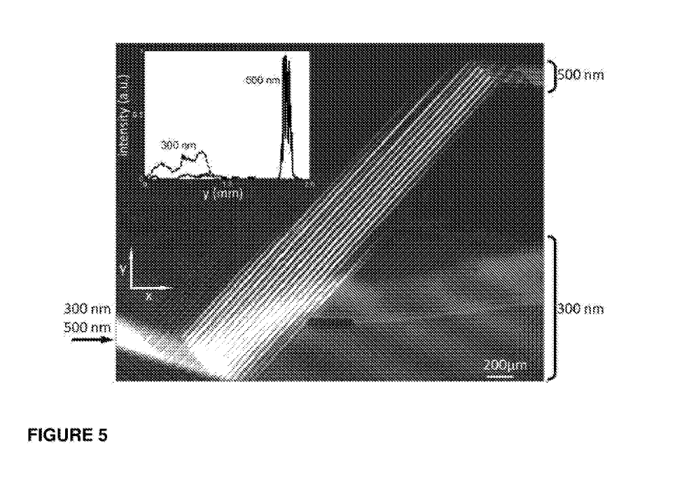

An advantage of the vDLD device and system is that particles over a large size range can be similarly separated, requiring only a manipulation of flow rate and amplitude. Using the same device used to separate micron-sized particles as shown in FIGS. 3 and 4, the separation of sub-micron particles can be achieved. The viable separation of 300 nm and 500 nm particles (blue and orange, respectively) is shown in FIG. 5, despite the influence of brownian motion. Separation efficiency shown in the inset in FIG. 5 is determined by normalized image intensity of the final ten rows of pixels in the x-direction, rather than particle counting, as the particles could not be visualized directly.

SAW devices are uniquely applicable to microfluidic particle separation because: (1) they are planar and can be easily integrated with other microfluidic processes; (2) the wavelength of a typical SAW device (5-300 μm) is of the same order of most microfluidic systems; and (3) the localization of energy at the surface results in efficient transfer of energy to a fluid placed on top, and have therefore found application in microfluidic applications as diverse as atomization, mixing, concentration, pumping, droplet production and microcentrifugation.

FIG. 5 is an image of average particle intensity showing separation of fluorescent blue 300 nm and 500 nm orange (σ₃₀₀=39 nm, σ₅₀₀=16 nm) particles passing through the vDLD device of FIG. 1. 500 nm particles are observed to travel at an angle to the flow in the direction dictated by the pressure field. 300 nm particles subjected to the same acoustic field as the 500 nm particles experience a smaller acoustic force, their trajectory is determined instead by viscous drag. The inset in FIG. 5 shows an intensity plot of fluorescent particles with background subtracted; approximately 87% of 500 nm particle intensity, as measured by the integral of the intensity profiles, is separated from the 300 nm particle intensity distribution. There is approximately 13% overlap.

This vDLD device of the present invention takes advantage of the high frequencies and corresponding length scales associated with SAW. With the ability to separate particle populations of arbitrary dimensions, the vDLD device and method of the present invention can be applied to any field or application where deterministic separation of particles or cells by their physical properties is required.

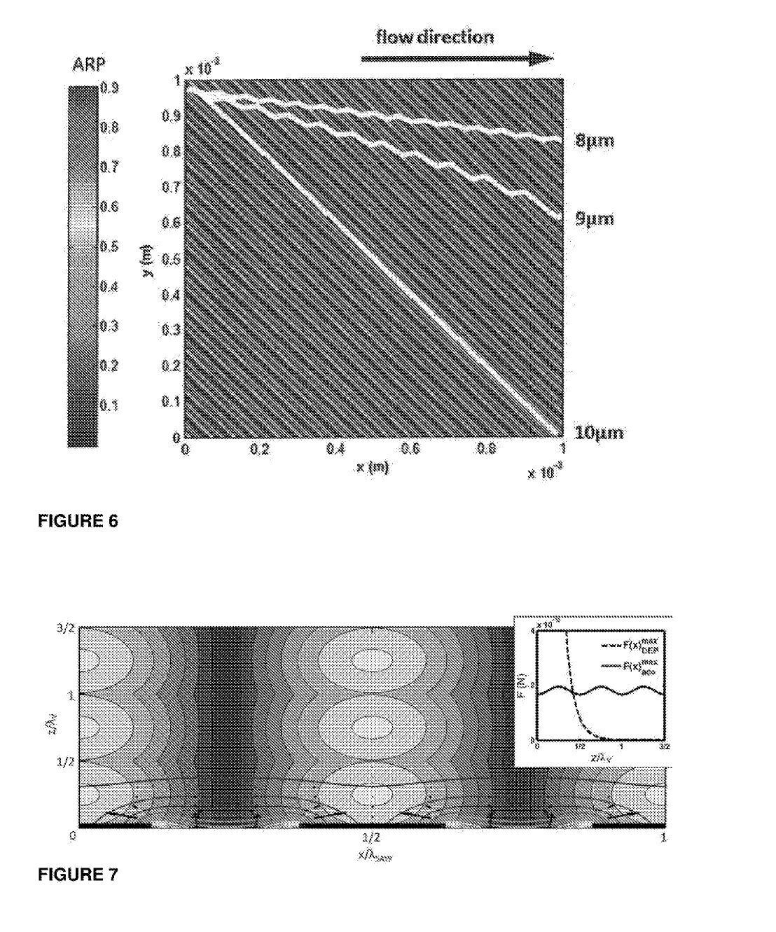

FIG. 6 shows simulated particle trajectories through a 1 mm×1 mm acoustic field tilted 45° relative to the flow direction. Colour contours denote the strength of the acoustic radiation pressure at a given point; blue being low strength and red being high strength.

A particle in the vDLD device is subject to forces of viscous drag F_{D}, the acoustic force F_{aco} and/or the DEP force F_{DEP}. As previously mentioned, the predominant force, DEP or acoustic, acting on a particle is determined by its distance above the IDTs, where DEP is dominant in the near-field and the acoustic force is dominant for larger distances from the transducers. FIG. 7 is a representation showing the relative importance of DEP and acoustic forces in one specific configuration of electrodes in an embodiment of the present invention. FIG. 7 shows the relative magnitude of DEP and acoustic forces in the vicinity of a set of IDTs. In this figure the acoustic pressure field magnitude is shown in gray 71. The first ten (10) DEP force potential contours are shown in colour 72 and the linearly scaled DEP force vectors in relation to the position of the IDTs are shown in black 73. For representative values of voltage and pressures (approximately 5 V, and approximately 100 kPa, respectively) that are generated on a piezoelectric substrate, such as lithium niobate, at frequencies of the order of tens (10s) of MHz on polystyrene particles in water, the maximum acoustic force in the x-direction F(x)ₘₐₓ^{aco} is dominant for heights greater than approximately half of the vertical acoustic wavelength in the fluid A as shown in the inset to FIG. 7.

The present invention uses a force field in which the force potential minima are at an angle to the fluid flow direction. This is a key difference to previous ultrasonic methods. In the present invention, the flowing fluid exerts a drag force on the particle, this drag causes the particle to move over force potential maxima (the of a hill and valley analogy) and thereby interact with multiple minima (corresponding to multiple ultrasonic wavelengths). These multiple interactions, which are not possible in existing systems, allow for highly refined particle sorting. At each interaction the crossover of the minima is better defined than in the prior art DLD method, so a short channel is sufficient. The multiple interactions accentuate the lateral offset for each particle type Experiments using the present invention show that highly specific sorting is achievable based on particle radius. In an experiment, 6 and 8 micron diameter particles were separated with higher accuracy than existing ultrasonic methods.

The method of the present invention is competitive with DLDs without the issues that the prior art DLD methods experience. In addition, the method of the present invention can be downsized to sort nanoparticles; for example, separation of virions could be achieved through sorting by a variety of physical properties, separation of graphene flakes could be achieved through sorting by area or separation of carbon nanotubes could be achieved through sorting by length. Furthermore, the present device, and method can be used to sort particles based on cell stiffness, for example, isolating diseased cells, and contrast. The degree of specificity, due to the low standard deviation in particle and location, allows the present invention to isolate rare cells with high reliability (for example, circulating tumour cells). Simulations using the present invention show that particles having a particular characteristic or property can be separated from a group of particles having a number of different characteristics or properties (that is, multiple particle populations are separable). The method and device of the present invention can be incorporated into hand-held diagnostics equipment because it is compact and has low power usage.

A significant advantage of the IDTs being located within the width of the channel and underneath the channel, is that the location of the IDTs improves the separation of particles based on the physical properties of the particles, for example, size, density, length, area or stiffness, or electrical properties of the particles. The present invention uses a periodic force field within the width of the channel to achieve superior sorting and advantages over prior art systems, devices and methods. In this way the particle has multiple interactions. This means that if a small difference results from each interaction this difference can be amplified and used for or used to refine separation such that the trajectory of migration through the system is highly specific with regard to the particle parameters.

Prior art methods, devices and systems use a single force potential minima in a channel to collect particles along a central axis of the channel. In these prior art systems there is a significant disadvantage because a link exists between frequency and maximum channel width such that only one potential minima is present along the channel axis. Also, there is a significant disadvantage of having the IDTs located outside the width of the channel due to attenuation of the acoustic signal that occurs as the acoustic waves propagate from the IDTs to the channel.

The present invention uses a periodic force field. By having the IDTs under the channel, and within the width of the channel, any width of channel can be used.

Variations can be made to the above-described arrangements without departing from the spirit or scope of the invention as described herein or as claimed in the appended claims.

1. A microfluidic device for separating or sorting particles in a fluid including:
a substrate;
a plurality of interdigital transducers on the substrate;
a microfluidic channel adapted to have fluid flow within, located over the interdigital transducers, the microfluidic channel having a width,
wherein:
the interdigital transducers are located within the width of the microfluidic channel; and
application of a signal to the interdigital transducers produces a force field at an angle to the fluid flow direction within the microfluidic channel.

2. A microfluidic device according to claim 1 wherein the force field is periodic.

3. A microfluidic device according to claim 1 wherein the force field is acoustic and/or electrical, preferably, dielectrophoretic (DEP).

4. A microfluidic device according to claim 1 wherein the substrate is glass, a non-piezoelectric material or a piezoelectric substrate.

5. A microfluidic device according to claim 1 wherein the interdigital transducers are in direct contact with fluid in the microfluidic channel.

6. A microfluidic device according to claim 1 wherein the interdigital transducers are separated from fluid in the microfluidic channel.

7. A microfluidic device according to claim 6 wherein the interdigital transducers are separated from fluid in the microfluidic channel by at least one intermediate layer.

8. A microfluidic device according to claim 1 wherein the particles are separated or sorted based on a physical property.

9. A microfluidic device according to claim 8 wherein the physical property is any one or more of size, density, length, area or stiffness.

10. A microfluidic device according to claim 1 wherein the particles are separated or sorted based on electrical properties, such that after travelling through the force field particles with different properties are physically separated.

11. A microfluidic device according to claim 1 wherein the particles to be sorted are an inhomogeneous body within a suspending medium, including any one of: a particle; nanoparticle; cell; virus; vesicle; carbon nanostructure or droplet.

12. A method for separating or sorting particles using a device having a plurality of interdigital transducers on a substrate and a microfluidic channel located over the interdigital transducers, the method including:
positioning the interdigital transducers within the microfluidic channel width;
inserting into the microfluidic channel a solution having particles with various properties; and
applying a signal to the interdigital transducers to produce a force field at an angle to a fluid flow direction within the microfluidic channel to sort and/or physically separate the particles into groups of particles with the same property.

13. A method according to claim 12 wherein the force field has a strength, the method further including the steps of tuning the fluid flow and tuning the force field strength to define separation particle size.

14. A method according to claim 13 where in the step of tuning the force field strength is determined by the distance between the interdigital transducers and the fluid in the microfluidic channel or the distance between the interdigital transducers and the particles in the microfluidic channel.

15. A method for separating or sorting particles according to claim 12 using the device of claim 1.

16. A method according to claim 12 wherein the particles are separated or sorted based on a physical property.

17. A method according to claim 16 wherein the physical property is any one or more of size, density, length, area or stiffness.

18. A method according to claim 12 wherein the particles are separated or sorted based on an electrical property.
